(19) United States
(12) Patent Application Publication
(10) Pub. No.: US 2026/0051171 A1
(43) Pub. Date: Feb. 19, 2026

(54) System

(71) Applicant: Softbank Group Corp., Tokyo (JP)

(72) Inventor: Takanori Ishii, Tokyo (JP)

(21) Appl. No.: 19/301,294

(22) Filed: Aug. 15, 2025

(30) Foreign Application Priority Data
Aug. 19, 2024 (JP) 2024-138329

(51) Int. Cl. G06V 20/50

(52) U.S. Cl. CPC G06V 20/50

(57) ABSTRACT

A system includes a processor that acquires image data using a camera worn by a user, acquires location information, transmits the image data and the location information to a server via a communication network, causes the server to analyze the image data and the location information, causes the server to generate feedback for the user based on the analysis result, transmits the feedback to the user via the communication network, and outputs the feedback as audio.

### CROSS-REFERENCE TO RELATED APPLICATION

This application claims priority under 35 USC 119 from Japanese Patent Application No. 2024-138329 filed Aug. 19, 2024, the disclosure of which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

There is a need to enable users, including those with visual impairments or other risks, to safely and independently navigate their environment in real time. Conventional navigation aids do not sufficiently provide timely and accurate environmental feedback based on the user's current visual surroundings and location, and as a result, users face difficulties in sensing dangers such as traffic signals, obstacles, or changes in their path.

### SUMMARY

The present invention provides a system including a processor that acquires image data using a camera worn by the user and obtains the user's location information. The system transmits both the image data and the location information to a server via a communication network. The server analyzes this data, generates appropriate feedback based on the analysis, and transmits the feedback to the user, who receives it as audio output. This enables users to gain real-time awareness of their surroundings, facilitating safe and informed movement.

“Processor” means a hardware or software component capable of executing instructions, processing data, and controlling operations within the system.

“Image data” means digital information representing visual content captured by a camera, including photographs or video frames.

“Camera” means a device capable of capturing visual information from the surroundings, typically as digital images or video.

“User” means an individual who utilizes and interacts with the system, particularly those needing navigation or safety assistance. “Location information” means data specifying the geographical position of the user, such as coordinates obtained from GPS or other positioning technology.

“Server” means a remote or cloud-based computer system which receives, analyzes, and processes data sent from the terminal, and generates feedback.

“Communication network” means an infrastructure, such as wireless or mobile communication systems, enabling data transmission between the terminal and server.

“Feedback” means information generated in response to analyzed data, intended to assist or guide the user, which is provided through audio or other output methods.

“Audio output” means the process of converting feedback into sound so that the user can receive information aurally.

“Wearable device” means a portable electronic device designed to be worn on the body, such as glasses, earpieces, or clothing-integrated devices, to enable hands-free use.

“Fifth generation mobile communication system” means a wireless telecommunications standard, also referred to as 5G, enabling high-speed and low-latency data transmission.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions; and

FIG. 10 illustrates an emotion map mapping plural emotions.

FIG. 11 is a sequence diagram showing the flow of data processing system processing in Example 1.

FIG. 12 is a sequence diagram showing the flow of data processing system processing in Application Example 1.

FIG. 13 is a sequence diagram showing the flow of data processing system processing in Example 2.

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

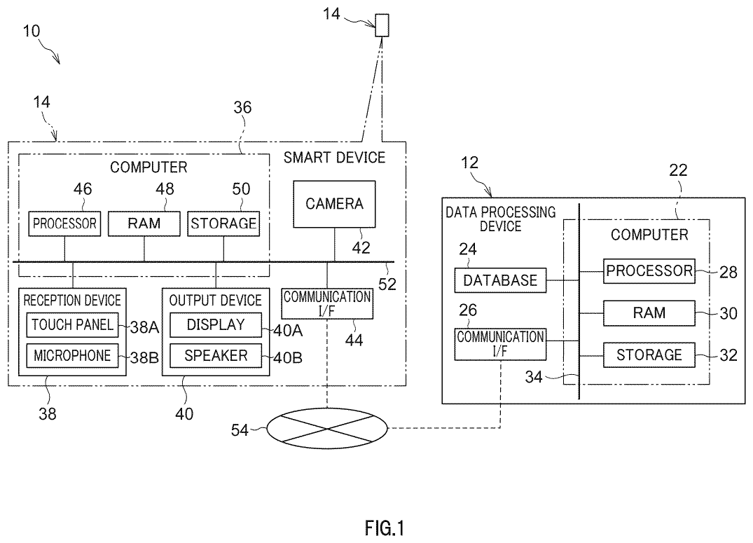

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

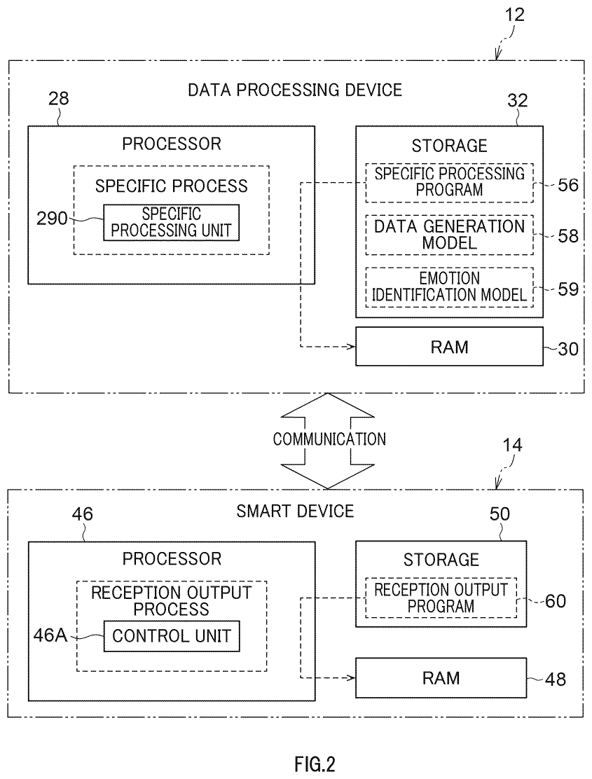

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Users with visual impairments or other risks have difficulty in autonomously and safely navigating their environment, as conventional systems often fail to provide real-time situational awareness and timely, context-appropriate feedback. Furthermore, prior technologies do not leverage generative artificial intelligence models to generate personalized feedback instructions in natural language based on a comprehensive analysis of imaging and positioning data.

The specific processing by the specific processing unit 290 of the data processing device 12 in Example 1 is realized by the following means.

The present invention provides a server including means for receiving imaging information acquired by a wearable imaging device and positioning information acquired by a positioning device, means for analyzing the information by performing object recognition processing and map information reference processing, means for generating natural language feedback content by inputting a prompt sentence including the analysis result and situation description into a generative artificial intelligence model, and means for transmitting the generated feedback content to the user via a mobile communication network for output by a voice output device. This enables real-time, highly personalized and context-sensitive guidance to be provided to at-risk users, improving their ability to act safely and independently.

The term “imaging device” refers to a hardware component, such as a camera, capable of capturing visual information in the form of digital image data.

The term “positioning device” refers to a hardware component, such as a global positioning system (GPS) module, capable of acquiring geographical location information of a user or object.

The term “information processing apparatus” refers to a computing device, such as a server or processing unit, configured to perform analysis and processing of received data.

The term “communication network” refers to any infrastructure that enables data transmission between devices, including but not limited to mobile communication networks such as cellular networks.

The term “object recognition processing” refers to computational techniques or algorithms for identifying and classifying objects, features, or conditions in image data.

The term “map information reference processing” refers to computational processes for accessing, retrieving, or referencing digital map data in connection with location information.

The term “generative artificial intelligence model” refers to a machine learning model capable of generating content, such as natural language instructions, in response to input prompts describing a current situation.

The term “prompt sentence” refers to an input query or descriptive sentence provided to a generative artificial intelligence model to solicit context-specific output.

The term “feedback content” refers to output information, in natural language, generated for the purpose of instructing or informing a user based on analyzed data.

The term “voice output device” refers to a hardware component, such as a speaker or earphone, capable of converting feedback content into audible sound for the user.

### Embodiment for Implementing the Invention

The system according to the present invention is configured to assist users, particularly those with visual impairments or with high-risk needs, by providing real-time, context-sensitive audio feedback based on the analysis of both imaging and positioning information. The system includes a wearable imaging device, a positioning device, a processor (server), a terminal held or worn by the user, a communication network, and a voice output device.

The user equips a wearable imaging device, such as a wearable camera positioned near eye level, and a positioning device capable of acquiring high-precision geographical location information; for example, a GPS module. These devices are connected to the terminal, which may be a smartphone or other portable information terminal.

The terminal, using internal control software, collects visual information (image data) from the wearable camera and location information from the GPS module. The terminal transmits these data, after optional preprocessing such as compression using software libraries (for example, H.265 for images and standard GPS data formatting), to a server via a communication network, such as a mobile or cellular network.

Upon receiving the imaging and positioning data, the server, implemented with high-performance computing resources, applies image analysis algorithms, such as object detection models (for example, neural networks based on the YOLO architecture or other general-purpose object recognition frameworks), to detect environmental features including road intersections, traffic lights, vehicles, stairs, and other relevant obstacles. The server also references digital map data, which may be obtained through map information APIs or databases, and correlates these map data with the acquired positioning data to provide spatial context for the recognized objects.

Once the environmental context is established, the server creates a prompt sentence that describes the user's situation. This prompt sentence is supplied to a generative AI model, such as a contemporary large language model, which then outputs natural language feedback content tailored to the user's current context. The server then transmits this feedback content to the terminal through the communication network.

The terminal uses a speech synthesis engine to convert the received natural language feedback into audible speech, which is then delivered to the user via a voice output device, such as an earphone or speaker. Additionally, the terminal can be configured to provide supplementary feedback, such as vibrations, to further assist the user in recognizing urgent or critical instructions.

A specific example is as follows:

When the user approaches an intersection, the imaging device captures the surroundings. The positioning device detects the user's present location. The terminal sends these data to the server. The server recognizes a red traffic light and creates the following prompt sentence for the generative AI model:

“There is a red traffic light at the intersection ahead. Please write an instruction for the user to stop and wait.”

The generative AI model returns a feedback sentence such as: “The traffic signal is red. Please stop and wait until it turns green.”

This sentence is converted to speech by the terminal and delivered to the user via an earphone. In another example, if the system detects a staircase ahead based on captured imaging data and map information, the prompt sentence may be:

“There is a staircase 10 meters ahead. Please compose a cautionary message for the user.”

The generative AI model may output: “There is a staircase approximately 10 meters in front of you. Please proceed with caution.”

The terminal synthesizes and outputs this guidance through the voice output device.

In this way, the system enables the user to receive highly personalized and contextually appropriate guidance in real time, thus improving independent mobility and safety for users with special needs. The system can be implemented using commercially available smartphones, wearable cameras, GPS modules, speech synthesis engines, general image processing frameworks, digital map APIs, and generative AI models accessible via cloud service APIs.

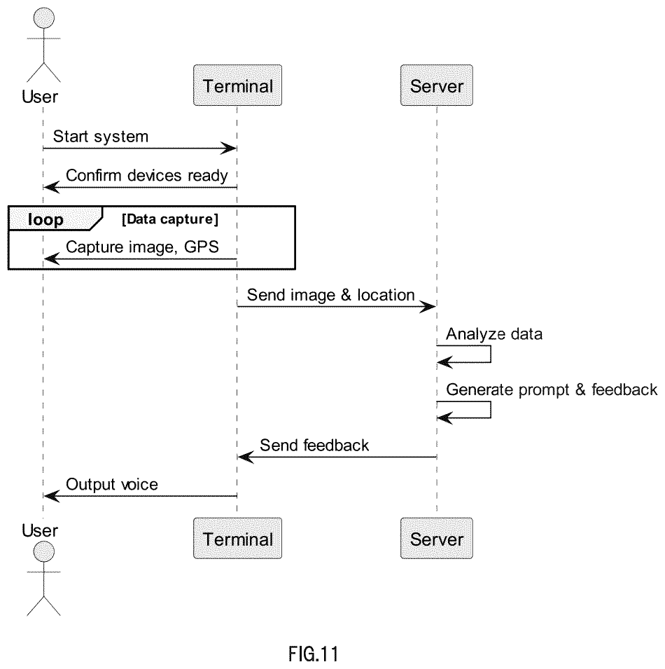

The following describes the processing flow using FIG. 11.

### Step 1:

User wears the wearable imaging device and positioning device, then activates the system using the terminal.
Input: None (system start)
Output: Devices are powered on, and the terminal establishes connections with the camera and GPS module.

The user physically mounts the camera near their eye level and confirms the system has started via an interface on the terminal.

### Step 2:

Terminal acquires imaging and positioning data from the connected devices at predetermined intervals (e.g., 30 frames per second for images, 1 Hz for GPS data).
Input: Continuous data stream from the imaging device and positioning device
Output: Time-synchronized image data and GPS data

The terminal assigns timestamps to incoming data, organizes each image with corresponding geographic coordinates, and stores the paired data temporarily in a local buffer.

### Step 3:

Terminal preprocesses the acquired imaging and positioning data and transmits the processed data to the server through the communication network.
Input: Time-synchronized buffered image data and GPS data
Output: Transmitted packets containing compressed image and coordinate data

Terminal compresses image data using suitable codecs, formats GPS data into standard strings, and packages them into transmission packets. It then sends these packets to the server over a mobile communication network, minimizing delay by prioritizing real-time transmission.

### Step 4:

Server receives and decodes the transmitted data from the terminal.
Input: Data packets containing compressed image and coordinate data
Output: Decoded image frames and positioning data for analysis

Server decodes the image using image processing libraries, parses location information, and logs the decoded data for further analysis.

### Step 5:

Server analyzes the decoded image and positioning data using image analysis and map information reference processing.
Input: Decoded image frames and positioning data
Output: Environmental context, including recognized objects, obstacles, and spatial relationships

Server applies an object recognition model to the image, such as a neural network-based detection algorithm, and queries a digital map database or API using the positioning data. The server correlates recognition results and map features to determine the user's current situation.

### Step 6:

Server generates a prompt sentence describing the environmental context and inputs this prompt sentence into the generative AI model.
Input: Environmental context (recognized objects and current location)
Output: Context-tailored prompt sentence and obtained natural language feedback Server constructs a descriptive prompt sentence based on analysis, then sends it to a generative AI model. For example, the server may generate, “There is a red traffic light at the intersection ahead. Please write an instruction for the user to stop and wait,” and obtains an instruction in natural language from the AI model.

### Step 7:

Server transmits the generated natural language feedback to the terminal via the communication network.
Input: Feedback output from the generative AI model
Output: Message packet containing the feedback for the terminal

Server packages the feedback as a message in a structured format and sends the message to the user's terminal for immediate delivery.

### Step 8:

Terminal receives the feedback message, converts it into speech using a speech synthesis engine, and outputs it to the user via a voice output device.
Input: Feedback message from the server
Output: Audible instruction delivered to the user and, if necessary, additional vibration feedback

Terminal processes the received text, synthesizes it into speech, and outputs it through an earphone or speaker. Optionally, the terminal activates a vibration device to provide supplemental tactile notification to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

There is a need for an advanced navigation assistance system that enables users with visual impairment, elderly users, or other users with mobility risks to safely and independently navigate inside commercial facilities and complex environments. Conventional navigation systems mostly rely on visual information and static maps, making them difficult to use for visually impaired users and ill-suited to adapt to frequently changing layouts or situational risks. Furthermore, current solutions do not provide adaptive guidance that considers the user's emotional state, which is essential for reducing stress and increasing safety during mobility.

The specific processing by the specific processing unit 290 of the data processing device 12 in Application Example 1 is realized by the following means.

The present invention provides a server including a processor configured to receive environmental image information, location information, and emotion state information acquired by devices carried or worn by the user, to analyze the environmental image information using object detection or environmental recognition processing, to compare location information with a map database, and to estimate the user's psychological state based on acquired emotion state information. The processor is further configured to employ a generative artificial intelligence model to generate and transmit, in natural language, real-time guidance information adaptive to the user's situational context and emotional state, the guidance being delivered via an audio output device. This enables users, including the visually impaired and elderly, to receive precise, adaptive, and emotion-aware navigational support, allowing them to move safely and autonomously in environments with dynamic layouts and changing risks.

The term “information acquisition device” refers to a general-purpose or specialized device worn or carried by the user, such as a wearable camera, that collects environmental image information in real time.

The term “location measurement device” refers to a device capable of determining the geographic or spatial position of the user, which may include a global positioning system (GPS) module or another location tracking sensor.

The term “biometric sensor” refers to a hardware component or integrated sensor module that acquires physiological data from the user, such as heart rate, skin conductance, or other biosignals relevant to emotional assessment.

The term “emotion estimation module” refers to a hardware or software component that analyzes user data, including voice, facial expressions, or biometrics, to determine or estimate the user's current emotional or psychological state.

The term “environmental image information” refers to digital data, such as photographs or video, representing the real-time surroundings of the user captured by an information acquisition device.

The term “location information” refers to digital data that describes the present geographic or spatial coordinates of the user, as determined by the location measurement device.

The term “emotion state information” refers to digital data reflecting the detected or estimated psychological or emotional condition of the user at a given time.

The term “information processing apparatus” refers to a general-purpose server, cloud platform, or computing device configured to process the image, location, and emotion data received from the user's devices.

The term “object detection processing” refers to a computational method for identifying and locating relevant entities, such as obstacles or products, within environmental image information, using techniques such as machine learning or computer vision.

The term “environmental recognition processing” refers to the process of analyzing environmental image information to comprehend the user's surrounding context and spatial arrangement.

The term “map data” refers to structured digital information describing the spatial layout, positions, and features of a given environment, which is used for location comparison and guidance generation.

The term “generative artificial intelligence model” refers to a software or algorithmic framework that uses machine learning, deep learning, or similar techniques to automatically generate natural language instructions or guidance based on input data and contextual analysis.

The term “communication network” refers to a system infrastructure, such as a mobile communication network or other data network, that enables transmission of data between the user's devices and the information processing apparatus.

The term “audio output device” refers to any device capable of converting digital or textual information into audible speech or sounds, such as a speaker, earpiece, or bone-conduction headset.

The term “guidance information” refers to natural-language navigational or situational advice generated and delivered to the user, which is adaptive to both the context and the emotional state of the user.

The present invention may be embodied as an advanced navigation and guidance system including a processor, a wearable information acquisition device, a location measurement device, a biometric sensor or emotion estimation module, a communication network, and an audio output device. The invention leverages cloud computing, advanced artificial intelligence models, and sensor integration to provide real-time, adaptive, and emotion-aware feedback for users with mobility or visual challenges.

The user wears a wearable information acquisition device, such as a smart glasses camera or a chest-mounted camera, which captures continuous environmental image information in the form of photographs or real-time video. Simultaneously, a location measurement device such as a global positioning system (GPS) module, or an indoor positioning system like Bluetooth beacons, acquires the spatial coordinates of the user. Further, biometric sensors such as a heart rate monitor or an emotion estimation module, for example an emotion analysis algorithm utilizing the user's voice, facial expression, or physiological signals, detect and estimate the emotion state of the user.

The terminal, which may be implemented as a smartphone or an embedded control unit in the wearable device, collects the environmental image information, location information, and emotion state information, and formats these data for transmission. This terminal device utilizes a mobile communication system, such as a fifth-generation (5G) communication network, to communicate with an information processing apparatus including one or more servers. Data transmission may be encrypted and structured using a standard data formatting protocol for security and reliability.

The server, as an information processing apparatus, receives and processes the transmitted data. The server is equipped with software modules such as an object detection algorithm (e.g., YOLOv5, OpenCV), an environment recognition module, a map database (e.g., a digital map API), an emotion classifier (e.g., a machine learning model for emotion detection), and a generative artificial intelligence model (e.g., a large language model). The server performs object detection and environmental recognition upon the environmental image information to identify obstacles, product sections, and layout features. Simultaneously, it compares the received location information with the map data to determine the current position and path of the user. The server analyzes emotion state information to estimate the psychological state of the user (such as anxious, calm, or stressed), which is used to adapt feedback content and style.

Based on these combined analysis results, the server crafts a prompt sentence for the generative artificial intelligence model. For example, the server may use the following prompt when generating navigation instructions:

“Given the detected results and the user's current location and emotional state, generate real-time spoken guidance for a visually impaired user to safely reach the fruit section, while providing calming support if anxious and avoiding the detected obstacle along the route.”

The generative artificial intelligence model then outputs natural-language guidance information tailored to the user's real-time environment and emotional state. This guidance information may include step-by-step navigation, reassurance, and warnings of dynamic risks.

The guidance information is transmitted from the server to the terminal through the communication network. The terminal receives the textual guidance and utilizes a text-to-speech (TTS) engine, such as cloud-based or local TTS software, to convert the text into an audio message. The audio output device, such as an earpiece, bone-conduction speaker, or smartphone speaker, presents the guidance in real-time to the user. In some embodiments, the terminal may also employ haptic feedback, using a vibration motor, to reinforce crucial information such as the presence of nearby obstacles or arrival at a destination.

As a concrete example, when a user in a supermarket intends to locate a specific product, the wearable camera continuously transmits environmental images while the GPS module reports the changing location. If the emotion sensor detects increased stress, the server identifies a nearby obstacle and the target product section, then generates and delivers a calm, encouraging navigation message, such as:

“Take a deep breath. There is a cart in front of you. Please step to the right, and you will find the fruit section eight meters ahead on your left.”

Prominent examples of prompt sentences employed by the generative artificial intelligence model in the system include:

“Generate real-time guidance for a user with impaired vision who is anxious and needs to avoid an obstacle while reaching the fruit section five meters to the left.”

“Design a natural-language navigation instruction that uses object detection and location data to safely guide a user to a target section, adjusting the message to be supportive in case of user stress.”

Thus, the system allows users to receive emotionally sensitive, context-aware, and dynamically adaptive navigation guidance, improving safety, independence, and user experience in both static and dynamic environments. The invention is adaptable to various configurations and sensor combinations, as long as the core process of real-time data collection, analysis, AI-powered guidance generation, and audio feedback is preserved.

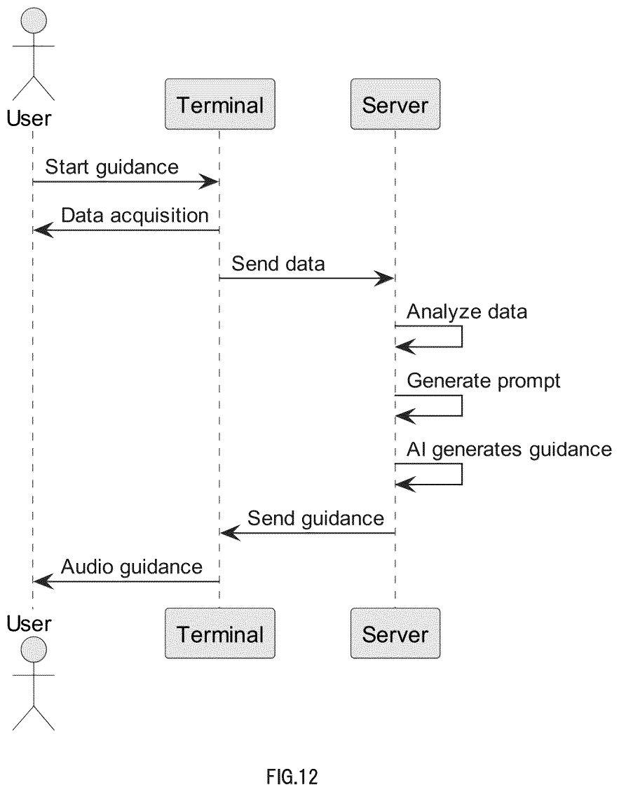

The following describes the processing flow using FIG. 12.

### Step 1:

User wears the wearable information acquisition device and initiates the guidance application. User begins moving within the environment, such as walking through a store or unfamiliar space.
Input: None (start of process).
Action: User physically activates the device and moves naturally within the space.
Output: Device is worn, and the system is started.

### Step 2:

Terminal activates the camera, location measurement module, and biometric/emotion sensors to collect current data at periodic intervals (e.g., every 1 second).
Input: User's physical environment, location, and physiological signals (such as images, GPS coordinates, heart rate, voice, or facial expression).
Action: Terminal captures an image of the environment, obtains the current GPS coordinates, and collects emotion state data from biometric sensors in real time.
Output: Data packet containing environmental image information, location information, and emotion state information.

### Step 3:

Terminal formats and transmits the collected data packet to the server over a communication network, using a secure transmission protocol.
Input: Data packet assembled in Step 2 (image, location, emotion state data).
Action: Terminal structures data into a standardized message format, establishes a connection to the server via a mobile communication system, and transmits the data packet.
Output: Data packet successfully received by the server.

### Step 4:

Server receives, unpacks, and pre-processes the incoming data, preparing it for analysis.
Input: Data packet from terminal (received image, location, and emotion state data).
Action: Server checks data integrity and timestamp, decompresses images, and stores incoming information in processing memory.
Output: Pre-processed data ready for analysis modules.

### Step 5:

Server performs object detection and environmental recognition processing on the environmental image information using machine learning models.
Input: Environmental image information from the pre-processed data.
Action: Server runs an object detection algorithm (such as an object detection neural network) to identify entities such as obstacles, product sections, or hazards in the image.
Output: Object detection results, including the classes and locations of detected elements.

### Step 6:

Server analyzes the received location information and compares it against map data to determine the user's current position and context within the environment.
Input: Location information from user and map data stored on or accessed by the server.
Action: Server queries the map database using the user's coordinates and determines spatial relationships, such as distance to target sections or proximity to obstacles.
Output: Location context and navigational information.

### Step 7:

Server estimates the user's psychological state based on the received emotion state information using an emotion classifier.
Input: Emotion state information from user (such as heart rate, facial features, or vocal tone).
Action: Server applies a machine learning or rule-based emotion estimation algorithm to classify the user's current emotional state (e.g., calm, anxious, stressed).
Output: User's estimated psychological/emotional state.

### Step 8:

Server constructs a prompt sentence for the generative AI model, incorporating results from object detection, location analysis, and emotion estimation.
Input: Object detection results, location context, and user's emotional state.
Action: Server prepares a text prompt describing the current environment, user's location, and user's psychological condition.
Output: Complete prompt sentence for input to the generative AI model.

### Step 9:

Server sends the prompt to the generative AI model, which generates natural-language guidance information adaptive to the user's context and emotional state.
Input: Prompt sentence constructed in Step 8.
Action: Generative AI model processes the prompt and outputs a natural-language instruction or guidance message, using internal knowledge and learned language patterns to ensure supportiveness and relevance.
Output: Guidance information text targeted to the user's real-time needs.

### Step 10:

Server transmits the generated guidance information in text format back to the terminal via the communication network.
Input: Guidance information text.
Action: Server formats the guidance message for secure transmission and sends it to the terminal.
Output: Guidance message received by the terminal.

### Step 11:

Terminal receives the guidance information text and converts it into audio using a text-to-speech (TTS) engine.
Input: Guidance information text received from server.
Action: Terminal invokes the TTS engine, processes the text, synthesizes speech, and prepares an audio file or stream.
Output: Audio data containing the spoken guidance message.

### Step 12:

Terminal outputs the audio data through the audio output device (e.g., earpiece, bone-conduction speaker) for the user to hear. Optionally, the terminal provides haptic feedback by vibrating when critical warnings are included.
Input: Audio guidance data and vibration command (if applicable).
Action: Terminal plays the audio message in real time through the output device and triggers vibration as appropriate.
Output: User receives real-time audio (and optionally haptic) guidance.

### Step 13:

User perceives the guidance and continues to move safely and independently, following the instructions received. User's ongoing behavior and environment changes are continuously monitored by repeating Steps 2 and onward.
Input: Audio (and possibly vibration) feedback.
Action: User navigates the environment according to the guidance, while remaining under system observation and support.
Output: Improved safety, independence, and navigation success for the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

There is a need for a real-time support system that enables users, such as individuals with visual impairments, to accurately perceive their surrounding environment and possible risks, and to take appropriate actions independently and safely. Conventional technologies do not adequately coordinate environmental recognition, location information, and the user's emotional state to generate customized, context-aware, and timely feedback. Furthermore, existing systems often lack the ability to analyze multiple sources of sensor and user data, such as wearable images, geographic coordinates, and biometrics, and to deliver user-specific, emotionally adaptive support in a seamless manner suitable for dynamic real-world navigation.

The specific processing by the specific processing unit 290 of the data processing device 12 in Example 2 is realized by the following means.

The present invention provides a server including a processor configured to acquire, by a wearable electronic device, image information of the surrounding environment, acquire the current position by location information acquisition means, obtain biological information and generate emotional state information, transmit these data via a communication network, analyze the image to extract object information with an object recognition unit, determine the surrounding geographic context using a map information unit, evaluate the user's emotional state, generate behavioral support information based on all inputs, and further generate and transmit personalized audio feedback using a generative artificial intelligence model or response generation means, to a user terminal for presentation as audio or tactile output. This enables users, including those with visual impairments or similar challenges, to receive real-time, situation-and emotion-aware guidance, thereby facilitating independent and safe behavior in varied and changing environments.

The term “electronic device” refers to a general-purpose or dedicated hardware apparatus that is capable of acquiring data, processing information, and interfacing with external sensors or modules, and is wearable by a user.

The term “image information” refers to digital data representing visual information captured from the surrounding environment by a camera or imaging sensor.

The term “location information acquisition device” refers to any apparatus, including but not limited to a satellite positioning system receiver or network-based localization module, that determines the current position of the user.

The term “current location information” refers to data indicating the real-time geographic coordinates or position of the user in a form suitable for computational processing. The term “biological information acquisition device” refers to a hardware module capable of measuring biological signals from the user, such as heart rate, voice, skin conductance, or other physiological parameters.

The term “emotional state determination information” refers to processed data or a data structure representing the inferred emotional status of the user, generated by analyzing biosignals and/or behavioral cues.

The term “communication network” refers to any system of interconnected communication means, including wired or wireless data transmission, supporting the exchange of information between the electronic device, server, and related components.

The term “processor” refers to one or more computational units capable of executing instructions and processing the acquired data to perform analysis and generate output, which may be implemented in a server or other computing environment.

The term “object recognition information processing unit” refers to a computational module, algorithm, or subsystem capable of analyzing image information in order to extract object-related features, such as identifying traffic signs, obstacles, or other environmental elements.

The term “map information management unit” refers to a software or hardware module that manages, accesses, and processes geographic or mapping data to spatially contextualize current location information.

The term “behavioral support information” refers to data generated on the basis of analysis of environmental, positional, and user state inputs, specifying recommended actions or guidance for the user.

The term “generative artificial intelligence model” refers to an algorithmic system utilizing machine learning or deep learning methods capable of producing context-specific outputs, such as custom-generated audio messages, based on input data and pre-trained models.

The term “response generation unit” refers to a component configured to synthesize or select output messages based on analyzed input data, and may include generative or rule-based response mechanisms.

The term “user terminal” refers to a device accessible by the user, capable of receiving and presenting feedback, and equipped with necessary interfaces such as speakers, headphones, or haptic devices.

The term “presentation unit” refers to any module or subsystem that converts data received from the processor into modalities perceivable by the user, such as audio playback units or tactile (haptic) feedback generators.

The term “audio information” refers to data or signals that are intended to be output as sound, including generated speech or audio cues, serving as output guidance or messages for the user.

The term “tactile output” refers to output signals or stimuli designed to be perceived through the user's sense of touch, such as vibration or haptic feedback generated by actuators within the wearable device or user terminal.

### Embodiment for Implementing the Invention

A suitable embodiment of the present invention provides a system in which the user wears a portable electronic device, such as a wearable camera and biosignal sensor, and carries a terminal equipped with a communication module and local processor. The terminal interacts with an information processing device, or server, through a communication network, which may include multiple generations of mobile communication systems.

The wearable electronic device, which may include a general-purpose camera module and a biosignal acquisition unit, is fixed on the user's body. The terminal may be implemented as a smartphone, a smartwatch, or a dedicated embedded hardware device, capable of collecting image information, location information, and biological signals such as heart rate, voice signal, and skin conductance.

The terminal acquires image information by controlling the wearable camera at regular intervals, for example, every one second. It also uses GPS modules or other location information acquisition devices to obtain the current geographic position of the user. Biological information is acquired via sensors embedded in the wearable or paired with the terminal via wireless protocols such as Bluetooth Low Energy (BLE). The terminal receives heart rate through a compatible heart rate sensor and records voice input through an integrated microphone.

Using embedded software such as a pre-trained TensorFlow Lite emotion recognition model or a similar emotion inference library, the terminal processes the acquired biosignals to generate emotional state determination information. All acquired data—image, location, emotion—is composed into a structured data package that is transmitted to the server via a secure data transmission protocol, utilizing a communication module capable of 5G or other mobile connectivity standards.

The server is configured as a computational node, for example, a cloud-based hardware instance with a general-purpose processor and, if necessary, graphical processing units for accelerated machine learning inference. The server receives data packets from the terminal and stores them in an appropriate data storage system, such as a relational database or a distributed file storage service.

To analyze the surrounding environment, the server invokes an object recognition information processing unit, such as a deep learning-based detection algorithm (for example, YOLOv5 implemented through PyTorch). This processing extracts information about relevant objects present in the transmitted image, such as traffic lights, vehicles, crosswalks, and obstacles. Furthermore, the server calls a map information management unit, which may interface with an external web-based mapping service, to convert raw location coordinates into context information, such as the name of the street, intersection, or proximity to known risk areas.

The server analyzes the emotional state determination information to evaluate the user's physical and emotional status. By combining object information, location context, and user state, the server generates behavioral support information that describes a recommended action for the user.

The server may employ a generative artificial intelligence model, such as a large language model, or a response generation unit to compose tailored feedback adapted to both the environment and the user's emotional state. This feedback is generated as audio information in natural language, using, for example, a text-to-speech pipeline or advanced AI dialogue algorithms.

The generated audio (and, optionally, tactile) information is packaged and transmitted to the user terminal via the communication network. The terminal receives the feedback, converts it into a modality suitable for the user—such as playing synthesized speech through a speaker or wearable earphone, and activating a vibration motor for tactile cues.

As a result, the user receives real-time, comprehensive, and adaptive guidance, enabling safe and independent navigation in complex or hazardous environments, particularly valuable for persons with visual impairment or other sensory challenges.

For example, consider a visually impaired user approaching a busy city intersection. The terminal acquires images showing the presence of a traffic light, obtains the user's location, and records a rising heart rate and anxious tone from the user's speech. The server analyzes all data, determines that the crossing is currently unsafe, and, recognizing the user's stress level, generates a gentle, reassuring voice message: “The traffic light is red. Please wait. I will let you know when to cross safely.” This message is transmitted back to the terminal and delivered as audio, while the terminal may also gently vibrate to reinforce the notification.

Example prompt sentences for the generative AI model include:
“Generate a calming and descriptive audio message for a visually impaired pedestrian at an intersection, who is feeling anxious and needs to wait for a green light. The message should be both informative and soothing. ”
“Explain how a terminal gathers sensor and emotional data, sends it over 5G, and how a server generates personalized safety guidance for visually impaired users using generative AI. ”

Through this embodiment, the coordinated use of multiple sensor data types, advanced information analysis, and generative artificial intelligence enables a highly adaptive support system for safe and independent user behavior.

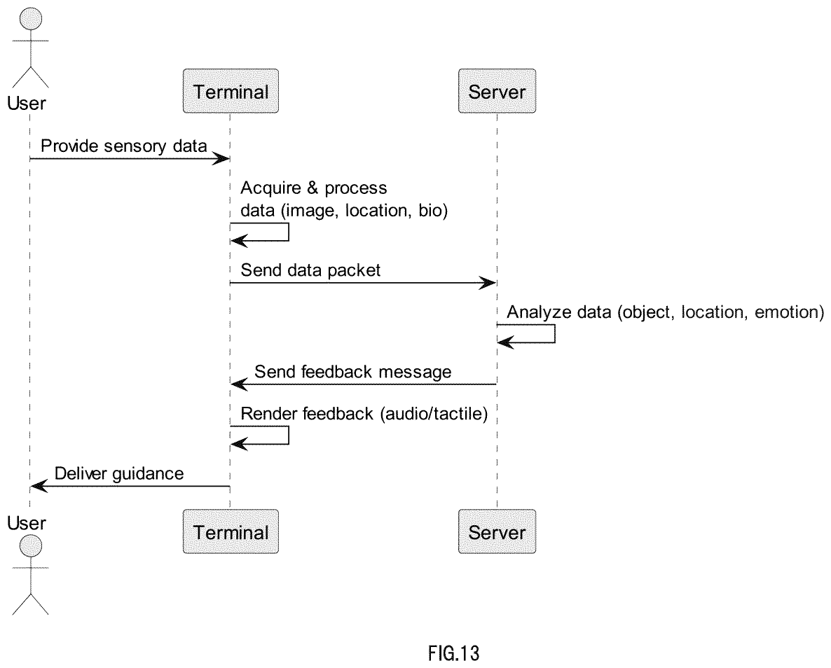

The following describes the processing flow using FIG. 13.

### Step 1:

Terminal acquires sensory input by activating the wearable camera to capture environmental images, polling the GPS module to obtain the current geographical location, and collecting biosignals such as heart rate and voice input through connected biometric sensors.
Input: Signals from camera, GPS module, microphone, and biosignal sensors.
Processing: Terminal synchronizes the sensor readings, formats them, and temporarily stores the image file, geographic coordinates, and biosignal raw data.
Output: Time-stamped image data, location information (latitude and longitude), raw heart rate, and audio sample file.

### Step 2:

Terminal processes biosignal data to determine the user's emotional state by using a local emotion recognition model (for example, a pre-trained TensorFlow Lite model) to analyze the heart rate data and voice tone.
Input: Raw heart rate and voice audio sample.
Processing: Terminal inputs heart rate data to an emotion detection algorithm and extracts audio features (such as pitch, volume, and speech rate) from the voice input, combining results for emotion classification.
Output: Emotion state label, such as “calm” or “anxious. ”

### Step 3:

Terminal compiles the image data, location information, and determined emotion state into a structured data packet and transmits it to the server using a secure 5G communication link.
Input: Image data, location data, emotion state.
Processing: Terminal serializes the different data components into a unified package (e.g., JSON or Protobuf), establishes a secure socket connection over the cellular network, and sends the packet to a designated server endpoint.
Output: Data packet sent and received by the server.

### Step 4:

Server receives the data packet, extracts and stores the image, location, and emotion state in a secure database, and begins parallel processing of the received sensory data.
Input: Data packet containing image, location, and emotion state.
Processing: Server parses the packet, saves each data element, and dispatches tasks to specialized analytical modules.
Output: Accessible, time-stamped records of the image, geolocation, and user emotion in server storage.

### Step 5:

Server analyzes the image using an object detection algorithm (such as YOLOv5) to identify environmental features like traffic lights, vehicles, and obstacles, and queries a mapping service to contextualize the location.
Input: Image data and location information.
Processing: Server loads the image into the object detection model for feature extraction, sends the coordinates to a map API to retrieve address and geographical context, and merges the results.
Output: Environmental object list (e.g., traffic light: red, cars: 2), location context (e.g., intersection at Main St. and First Ave).

### Step 6:

Server integrates the environmental analysis, location context, and user's emotional state to generate behavioral support information recommending an optimal action for the user.
Input: Environmental object list, location context, emotion state.
Processing: Server applies decision logic or AI reasoning to match situational risks and user state with a recommended behavior (such as “wait,” “proceed,” or “sidestep obstacle”).
Output: Behavioral support message with suggested user action.

### Step 7:

Server generates a personalized feedback message by invoking a generative AI model or rule-based response system that creates audio information tailored to the user's emotional state and environmental context.
Input: Behavioral support message, emotion state, situational details.
Processing: Server either retrieves a predefined message template or sends a prompt to a generative AI model to compose a custom audio message.
Output: Personalized textual feedback message.

### Step 8:

Server transmits the generated feedback message to the terminal through the 5G communication network.
Input: Personalized feedback text.
Processing: Server serializes the message and sends it to the user's terminal endpoint over the secure network.
Output: Feedback message packet received by the terminal.

### Step 9:

Terminal renders the feedback for the user by converting the received text message into synthesized speech via a text-to-speech engine and, if designated, optionally triggers vibration cues for tactile feedback.
Input: Feedback message packet.
Processing: Terminal processes the message for the selected synthesis method, plays audio through an earpiece or speaker, and, if necessary, activates the haptic actuator.
Output: Spoken feedback and/or tactile signals perceptible by the user.

### Step 10:

User receives the real-time audio and/or tactile feedback, interprets the guidance, and uses this information to make independent and safe navigation decisions in the present environment.
Input: Audio and/or vibration guidance.
Processing: User listens and reacts accordingly; may request clarification or repeat as needed using a local input.

### Output: Safe and Informed User Actions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In industrial environments, it is difficult to monitor a worker's surroundings and emotional state in real time and to provide timely and appropriate feedback for ensuring occupational safety and improving operational efficiency. Conventional systems face challenges in accurately detecting environmental risks, evaluating the user's mental or physical condition, and providing flexible, situation-aware guidance that takes both external and internal conditions into account. As a result, workers remain exposed to safety risks and productivity loss due to inadequate and non-adaptive feedback.

The specific processing by the specific processing unit 290 of the data processing device 12 in Application Example 2 is realized by the following means.

The present invention provides a server including a processor configured to acquire visual information of a user's surroundings via an information acquisition device, acquire spatial information indicating the user's current location, acquire biological information and estimate an emotional state of the user, transmit such data to an information processing apparatus, analyze the visual and biological information to identify relevant objects and evaluate the user's emotional state, generate feedback information using a generative AI model with a context-derived prompt sentence, and deliver feedback to the user as audio or the like through a communication path. This enables real-time, context-sensitive support tailored to both the environmental conditions around the user and the user's mental or physical state, significantly improving safety and efficiency in the workplace.

The term “processor” refers to an electronic data processing apparatus configured to execute instructions for acquiring, analyzing, and processing information within the system. The term “information acquisition device” refers to a generic device, such as a sensor or camera, that obtains data representing an environment surrounding a user.

The term “visual information” refers to image data or other optical data acquired from the user's environment by an information acquisition device.

The term “spatial information” refers to data that indicates the location or position of a user, typically represented as coordinates obtained by a position detection device.

The term “position detection device” refers to a device, such as a global navigation satellite system receiver or other location-tracking component, used to determine the current position of a user.

The term “biological information” refers to data indicating the physiological or psychological state of the user, including, but not limited to, heart rate, biometric signals, or vocal attributes.

The term “emotional state” refers to a psychological evaluation of the user's current mental or physical condition, estimated from biological information.

The term “information processing apparatus” refers to a computing entity, such as a server, that receives, analyzes, and processes data transmitted from other devices in the system.

The term “communication path” refers to any network or transmission medium, including wireless or wired connections, enabling the exchange of data between devices in the system.

The term “generative AI model” refers to a type of artificial intelligence algorithm or software that generates output, such as natural language feedback, based on input data and context.

The term “prompt sentence” refers to a text input provided to the generative AI model, which defines the content, context, or instructions for generating suitable output.

The term “feedback information” refers to data, including instructions, warnings, or advice, generated by the information processing apparatus based on analysis of acquired information for the purpose of informing or aiding the user.

The term “audio information” refers to data or signals converted into sound, such as speech or alerts, which can be delivered to the user through speakers or similar devices.

The term “wearable information terminal” refers to a portable electronic device, such as smart glasses or another form of body-worn apparatus, capable of acquiring, processing, and communicating information as part of the system.

The term “mobile communication network” refers to a wireless infrastructure compliant with standardized protocols, which supports data exchange between system components in a mobile or distributed environment.

An embodiment for implementing the invention will be described in detail below. One exemplary embodiment of the present system includes a wearable information terminal, such as smart glasses, and a processing server equipped with artificial intelligence functionalities. The user wears the terminal, which consists of a camera, a position detection device (such as a GPS module), a biological information acquisition device (such as a heart rate sensor or microphone), and a wireless communication device compatible with a mobile communication network.

The terminal is configured to continuously capture visual information of the user's surroundings by means of its built-in camera. At the same time, the terminal acquires spatial information indicating the user's current position through the position detection device. Furthermore, the biological information acquisition device collects physiological and/or vocal signals to derive the user's biological information. The terminal incorporates an emotion estimation function that preliminarily evaluates the user's emotional state based on these biological signals, for example, through signal processing software specialized for biometric data or speech features.

The terminal packages the acquired visual, spatial, and biological information and transmits the data periodically, such as every second, to the server via the mobile communication network (e.g., 5G or LTE network infrastructure provided by standard wireless communication equipment).

Upon receiving the data, the server unpacks and processes the information using several analytical software modules. For image analysis, the server utilizes object detection algorithms, such as an image recognition model (e.g., YOLOv5 running on a Python and PyTorch environment), to recognize risk factors like moving vehicles, hazardous objects, or persons within the visual scene. The server further references stored environmental or location data, such as a digital map database, to relate the spatial information to specific zones within the facility.

For emotion evaluation, the server operates a machine learning model for emotion recognition (for example, using a TensorFlow-based emotion model) to analyze the received biological information and deduce the user's emotional state, such as calm, stressed, or fatigued.

Based on the combination of detected objects, mapped location, and the user's estimated emotional state, the server generates a prompt sentence. The server then provides this prompt sentence as input to a generative AI model (such as a large language model), which outputs an appropriate feedback message for the user. This generative AI model may reside on the same server or on a different accessible computing resource.

A concrete example of a prompt sentence is:
YOLOv5: Identify and classify objects in an image of a factory setting.
Model: TensorFlow emotion model to evaluate emotional state based on input biophysical data.
Scenario:
Object Detection Result: {‘forklift’: True}
Emotional state: ‘stressed’

Generate appropriate feedback for the above scenario considering both object detection and emotional state.

The output may be, for instance: “A forklift is approaching your position. Please stay vigilant and calm. If you feel stressed, take a short break.”

The server transmits the generated feedback message back to the terminal via the wireless communication network. The terminal receives the feedback and, using a speech synthesis engine (such as Google Text-to-Speech or a comparable tool), converts the text to audio information. This audio information is provided to the user through the terminal's built-in speaker or earpiece. Additionally, if required, the terminal may activate a vibration actuator to convey warnings or urgent information based on the content or urgency of the feedback.

By integrating these hardware components—wearable information terminal, information processing server, communication network—and software components—object detection algorithms, emotion recognition models, generative AI models, and speech synthesis tools—the system supports the user by providing real-time, context-aware feedback for ensuring safety and operational support.

For example, if the user is standing near a hazardous machine and shows signs of fatigue, the system will interpret the camera image (via object detection), determine the user's location in a hazardous zone (via spatial information), and detect a tired emotional state (via biological signal analysis). The generative AI model will then formulate and deliver a personalized message such as, “You appear fatigued near active machinery. Please exercise caution and consider taking a rest soon.”

In this way, the embodiment enables the comprehensive, adaptive support and risk mitigation intended by the present invention.

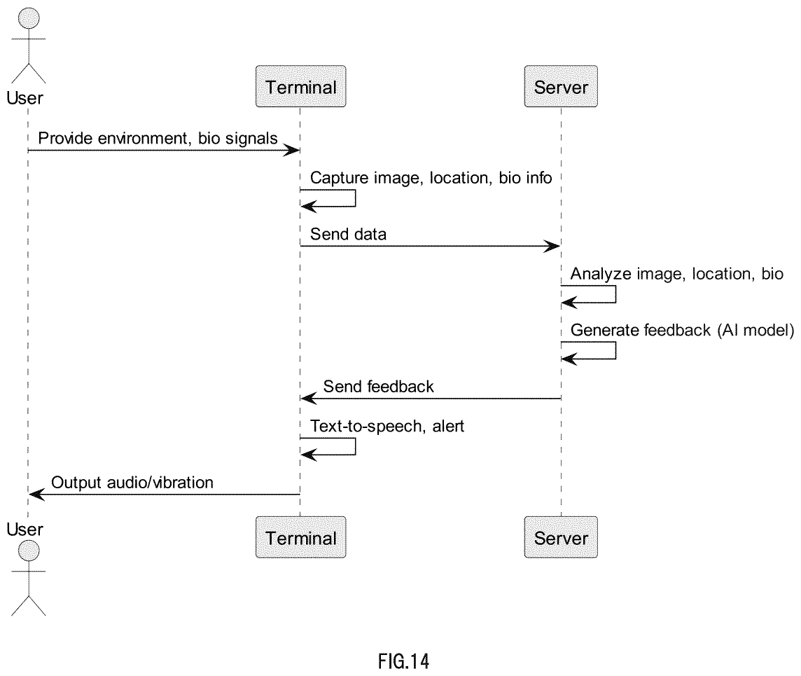

The following describes the processing flow using FIG. 14.

### Step 1:

The terminal captures visual information by using its built-in camera to take an image of the user's surroundings, simultaneously acquires spatial information using a position detection device, and collects biological information through sensors such as a heart rate monitor and microphone. The terminal processes the raw sensor signals to construct structured data, such as a JPEG image file, geolocation coordinates in text format, and a JSON object containing biometric readings.
Input: Environmental scene, location, and physiological signals directly from the user's context.
Processing: The terminal digitizes camera, location, and biosensor input, and aggregates these into a data package.
Output: A data package containing visual information, spatial information, and biological information.

### Step 2:

The terminal transmits the data package to the server via the mobile communication network. The terminal formats the package using the designated network protocol, establishes a connection with the server endpoint, and sends the packet at a predefined interval (e.g., every one second).
Input: Data package from Step 1.
Processing: The terminal encapsulates the data according to the communication protocol and handles error detection or retransmission as needed.
Output: Data package received by the server.

### Step 3:

The server unpacks and parses the received data. The server inputs the visual information into an object detection algorithm (for instance, an image recognition model), which analyzes the image to identify the presence, class, and position of predetermined objects such as hazardous machines or moving vehicles.
Input: Data package from the terminal (visual, spatial, and biological information).
Processing: The server performs image pre-processing, applies object detection, and extracts object class and location information.
Output: Object detection results indicating types and locations of detected items.

### Step 4:

The server evaluates the biological information with an emotion analysis model (such as a trained neural network). The server examines biometric features, such as heart rate variability and vocal tone, to estimate the user's emotional state, for example, “calm,” “stressed,” or “fatigued. ”
Input: Biological information from the user.

Processing: The server applies signal processing and machine learning algorithms to classify the emotional state.
Output: Estimated emotional state of the user.

### Step 5:

The server references the spatial information to determine the user's exact position within a facility map and assesses risk or context, such as proximity to dangerous zones or equipment.
Input: Spatial information and object detection results.
Processing: The server compares the user's coordinates with the digital map and cross-references with risk areas or asset zones.
Output: Contextual location and risk assessment data.

### Step 6:

The server generates a prompt sentence by combining the findings from object detection, emotion analysis, and location assessment. The server then inputs this prompt sentence into a generative AI model, which creates feedback tailored to the situation and emotional state.
Input: Object detection results, spatial/context data, and estimated emotional state.
Processing: The server constructs a textual prompt (for example, “Object detection result: {‘forklift’: True}; Emotional state: ‘stressed’; Generate appropriate feedback for this scenario.”) and uses this as input to the generative AI model via an API call.
Output: Generated feedback text.

### Step 7:

The server transmits the generated feedback message to the terminal over the mobile communication network. The server formats and sends the message as a text string and handles end-to-end delivery confirmation.
Input: Feedback text from Step 6.
Processing: The server encapsulates the feedback for transmission and manages communication protocol logistics.
Output: Feedback Message Received by the Terminal.

### Step 8:

The terminal receives the feedback message and uses a speech synthesis engine to convert the text feedback into audio data. The terminal then outputs the audio message to the user via its speaker, and, if necessary, activates a vibration actuator for urgent alerts.
Input: Feedback message from the server.
Processing: The terminal processes the text, synthesizes speech, and triggers actuators if needed.
Output: Audio (and potentially vibration) feedback provided to the user in real-time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

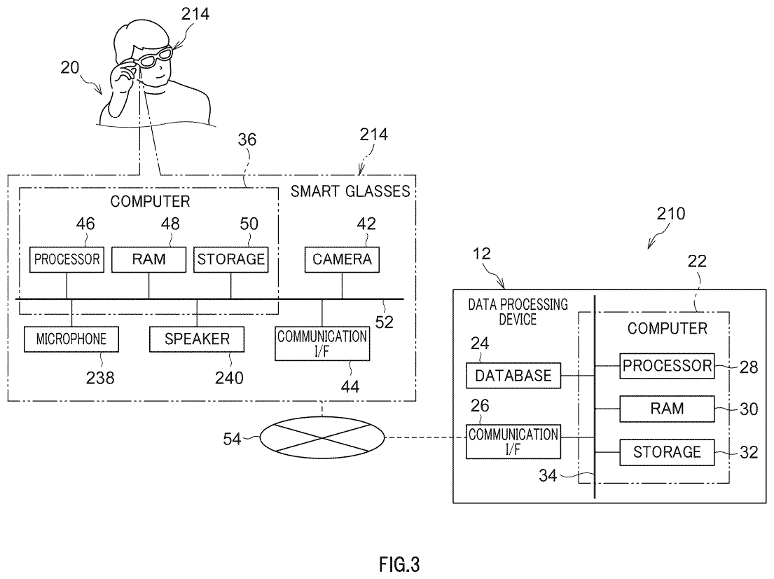

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

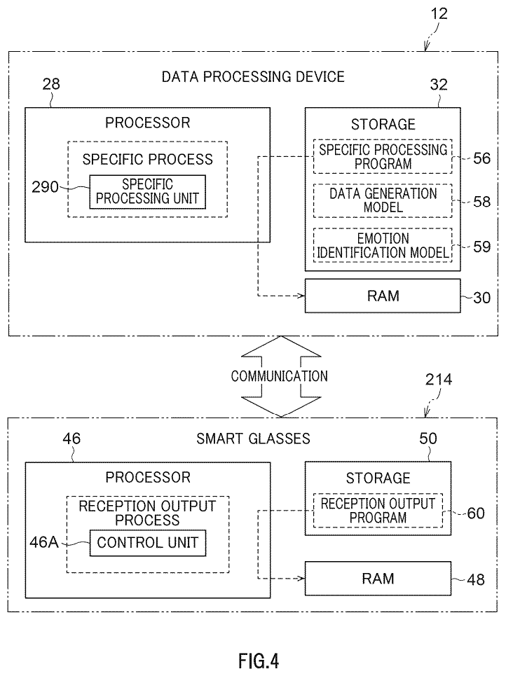

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

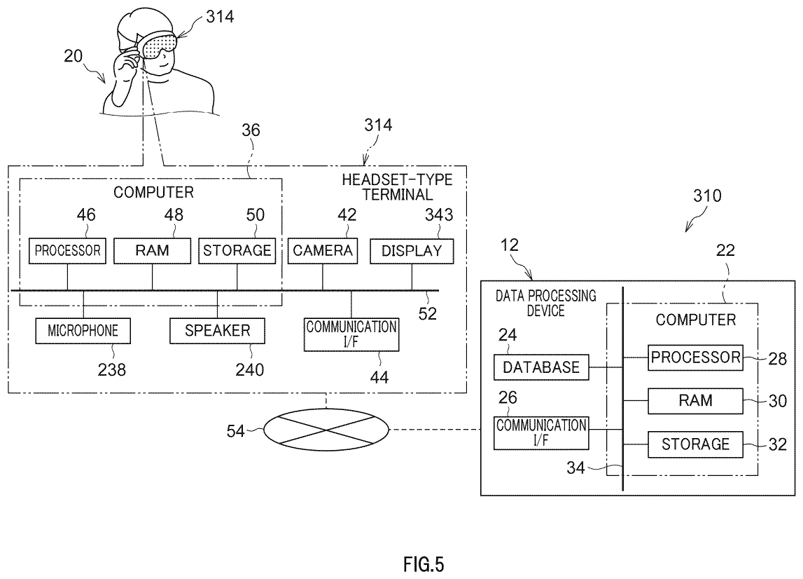

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

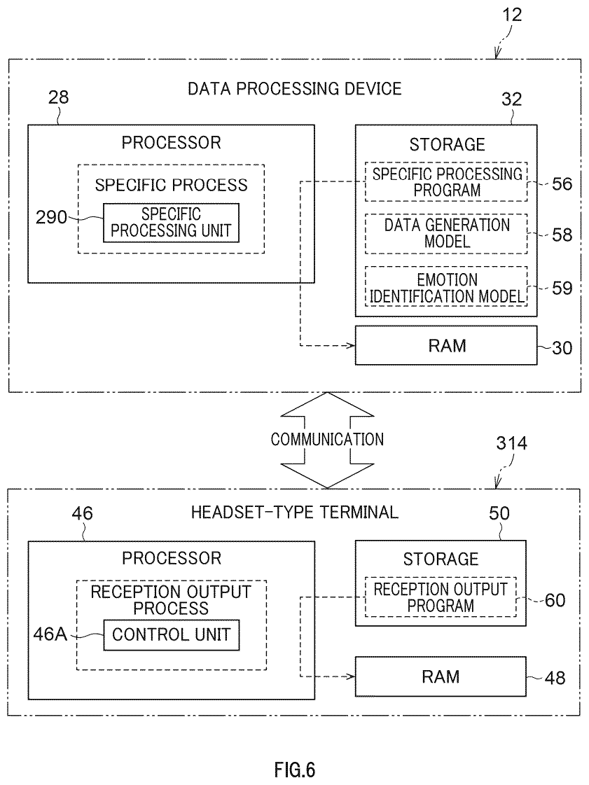

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

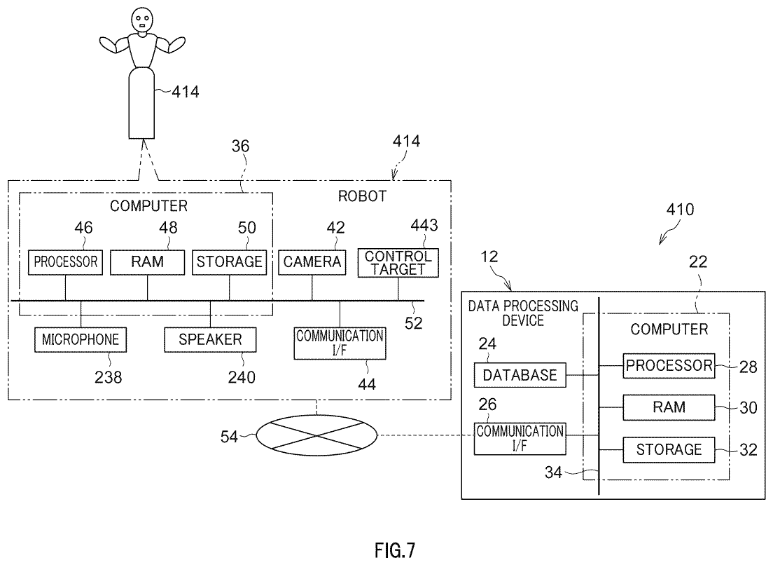

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

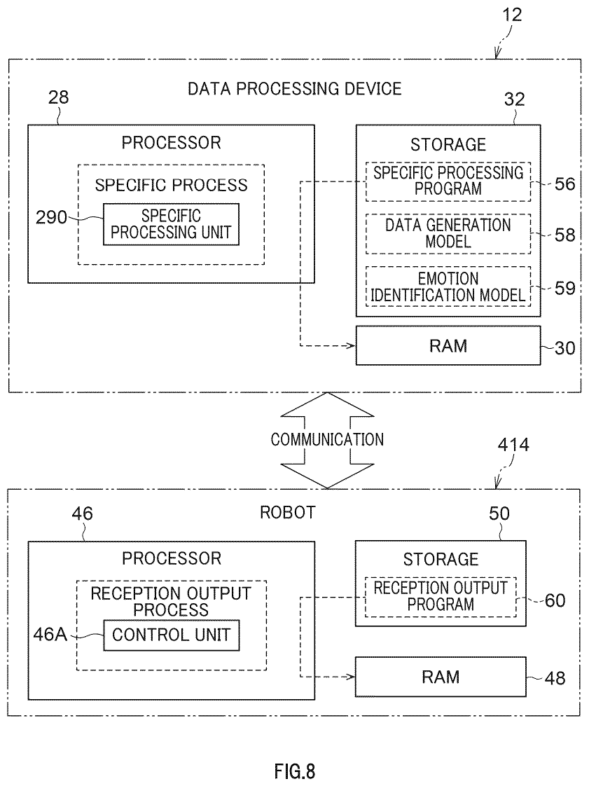

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

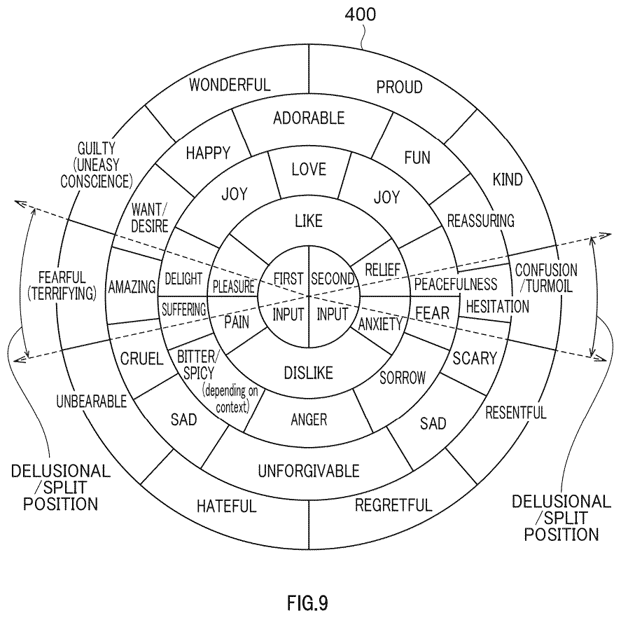

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

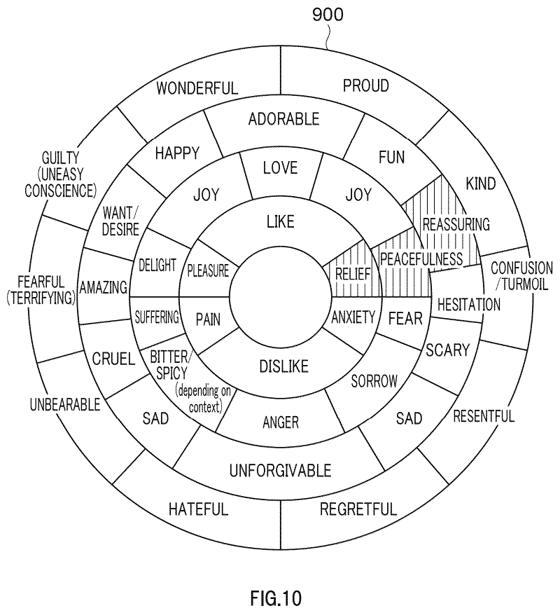

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
receive imaging information acquired by an imaging device worn by a user,
receive positioning information acquired by a positioning device,
transmit the imaging information and the positioning information to an information processing apparatus via a communication network,
analyze, at the information processing apparatus, the imaging information and the positioning information by performing object recognition processing and map information reference processing,
generate, at the information processing apparatus, feedback content in a natural language by inputting a prompt sentence including the analysis result and a situation description into a generative artificial intelligence model, and
transmit the feedback content to the user side via the communication network and output the feedback content by a voice output device.

### (Supplementary 2)

The system according to supplementary 1, wherein the imaging device is a wearable device.

### (Supplementary 3)

The system according to supplementary 1, wherein the communication network is a mobile communication network.

### Application Example 1

### (Supplementary 1)

A system including a processor,
wherein the processor is configured to
acquire environmental image information using an information acquisition device worn by a user,
acquire location information of the user by using a location measurement device, acquire emotion state information of the user by using a biometric sensor or emotion estimation module,
transmit the environmental image information, the location information, and the emotion state information to an information processing apparatus via a communication network,
perform object detection processing or environmental recognition processing on the environmental image information in the information processing apparatus,
compare the location information with map data in the information processing apparatus,
estimate a psychological state of the user based on the emotion state information in the information processing apparatus,
generate, by employing a generative artificial intelligence model, guidance information in natural language that is adaptive to the user's situation and emotion based on the analysis results, and
transmit the guidance information to an audio output device via the communication network and present the guidance information as audio to the user.

### (Supplementary 2)

The system according to supplementary 1, wherein the processor is configured to use a wearable device as the information acquisition device.

### (Supplementary 3)

The system according to supplementary 1, wherein the processor is configured to use a mobile communication system as the communication network.

### Example 2

### (Supplementary 1)

A system including a processor,
wherein the processor is configured to
acquire environmental image information by using an electronic device wearable by a user,
acquire current location information by using a location information acquisition device,
acquire biological information from a biological information acquisition device and generate emotional state determination information,
transmit the image information, current location information, and emotional state determination information to an information processing device via a communication network,
analyze the image information with an object recognition information processing unit to extract object information within the environment,
specify the surrounding geographical status using a map information management unit based on the current location information,
analyze the emotional state determination information to evaluate the user's state, generate behavioral support information based on the extracted object information, the specified geographical status, and the evaluated user state,
generate audio information adapted to the user's individual situation and emotional state via a generative artificial intelligence model or response generation unit, based on the behavioral support information, and
transmit the audio information to a user terminal via the communication network and provide it through a presentation unit using audio or tactile output.

### (Supplementary 2)

The system according to supplementary 1, wherein the electronic device is configured as a portable device wearable on the user's body.

### (Supplementary 3)

The system according to supplementary 1, wherein the communication network includes a plurality of generations of mobile communication networks.

### Application Example 2

### (Supplementary 1)

A system including a processor,
wherein the processor is configured to
acquire visual information representing an environment surrounding a user by using an information acquisition device attached to the user,
acquire spatial information indicating a current location of the user by using a position detection device,
acquire biological information of the user and estimate an emotional state of the user by using a biological information acquisition device,
transmit the visual information, the spatial information, and the biological information to an information processing apparatus via a communication path,
analyze the visual information in the information processing apparatus to identify a predetermined object,
evaluate the emotional state of the user by analyzing the biological information in the information processing apparatus,
generate feedback information in the information processing apparatus based on analysis results of the visual information, the spatial information, and the emotional state, the generating being performed using a generative AI model with a prompt sentence according to a situation, and
convert the feedback information to audio information or like and provide it to the user via the communication path.

### (Supplementary 2)

The system according to supplementary 1, wherein the processor is configured to acquire the visual information by means of a camera provided in a wearable information terminal.

### (Supplementary 3)

The system according to supplementary 1, wherein the communication path is a mobile communication network complying with a wireless communication standard.

What is claimed is:

1. A system comprising a processor,
wherein the processor is configured to:
acquires image data using a camera worn by a user;
acquires location information;
transmits the image data and the location information to a server via a communication network;
causes the server to analyze the image data and the location information;
causes the server to generate feedback for the user based on the analysis result;
transmits the feedback to the user via the communication network; and
outputs the feedback as audio.

2. The system according to claim 1, wherein the camera is mounted on a wearable device.

3. The system according to claim 1, wherein the communication network is a fifth generation mobile communication system.
